(19) United States
(12) Patent Application Publication
(10) Pub. No.: US 2014/0081843 A1
(43) Pub. Date: Mar. 20, 2014

(54) PRESENTATION INSTRUMENT LOADING

(71) Applicant: THE WESTERN UNION COMPANY, Englewood, CO (US)

(72) Inventors: Patty M. McKernan, Parker, CO (US); Scott R. Paintin, Littleton, CO (US); Andrew Moore Sullivan, III, Aurora, CO (US)

(73) Assignee: THE WESTERN UNION COMPANY, Englewood, CO (US)

(21) Appl. No.: 13/622,020

(22) Filed: Sep. 18, 2012

(51) Int. Cl. G06Q 20/28

(52) U.S. Cl. CPC G06Q 20/28
USPC 705/39

(57) ABSTRACT

Systems and methods are provided that allow consumers to reload prepaid accounts in-lane at a retail location without providing any personal identification such as a prepaid account numbers, an account number, name, etc. The systems and methods allow a consumer to establish a relationship with a reload package prior to paying for the reload package at the retail location.

### BACKGROUND

Prepaid cards are gaining prevalence as they can be used to support an increasingly wide variety of new payment transactions as people become more comfortable with their use. Historically, prepaid cards have been used as gift cards, reloadable prepaid cards, and for phone cards. In some situations funds related data are often physically stored on the cards themselves, or accessible by entering a code number on the card into a telephone, computer or other device.

The use of these prepaid cards has expanded to include government payments (e.g. benefits, food stamps, tax returns), incentives (both corporate employee incentives and merchant incentives for consumers), and is becoming an engine to drive user to user payments, including remittance. Today, there are several companies developing new payment platforms centered on the concept of virtual wallets; these wallets are also driven by stored value accounts. All of these services can benefit from programs that allow the consumer to easily load funds both offline and online.

There are several ways that consumers may currently load funds onto a prepaid card including, for example, using credit card, checks, ACH (Automated Clearing House) debit, payments at a physical location, and Paypal™.

### BRIEF SUMMARY

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim.

Embodiments of the invention are directed toward systems and methods for loading prepaid accounts. In some embodiments, an account number associated with a prepaid account can be received from a consumer at a money transfer platform or the like. A request to reload the prepaid account can also be received from the consumer. The request can include a reload identifier associated with a reload package. The account number and/the reload identifier can be associated together. This can be done, for example, in memory, a database, a file, etc. At some later point, the reload identifier can be received from an agent along with a fund amount. Using the reload identifier received from the agent, the account number can be identified and the associated prepaid account and/or account can be loaded with funds related to the fund amount. In some embodiments the reload identifier and the fund amount received from an agent does not include receiving the account number from the agent.

### BRIEF DESCRIPTION OF THE DRAWINGS

Illustrative embodiments of the present invention are described in detail below with reference to the following drawing figures:

FIG. 1 is a block diagram of a system that can be used to reload a prepaid account according to some embodiments of the invention.

FIG. 2 is a flowchart of a method for reloading a prepaid account according to some embodiments of the invention.

FIG. 3 is another flowchart of a method for reloading a prepaid account according to some embodiments of the invention.

FIG. 4 is a block diagram of a computer system capable of being used in at least some portion of the apparatuses or systems of the present invention, or implementing at least some portion of the methods of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention establish a reload relationship between a prepaid account, card or device and a reload package prior to purchase or activation of the reload package. This can be accomplished in a number of different ways. Embodiments of the invention can be used to ease and/or increase the efficiency of reloading funds. Embodiments of the invention can also allow consumers to reload funds onto their prepaid account using cash without divulging their account number to an agent.

As used herein the term “prepaid account” is a financial account associated with money that can be used in commerce using the prepaid account or a prepaid card or device associated with such prepaid account. A prepaid card can be any card associated with a prepaid account and/or capable of holding stored value, including a general purpose reloadable prepaid card. A prepaid device can be any physical or virtual mechanism associated with an account capable of holding stored value, including for example, a mobile telephone, computer, fob, mobile wallet or electronic wallet. Data that associates the funds available to the consumer can be maintained on computers affiliated with a card or device issuer, a processor and/or a program manager. Funds can be loaded on a prepaid account at various times and using various techniques. When loaded with funds, a prepaid account can be used like a debit and/or credit account. A prepaid account may or may not be associated with a prepaid card or prepaid device.

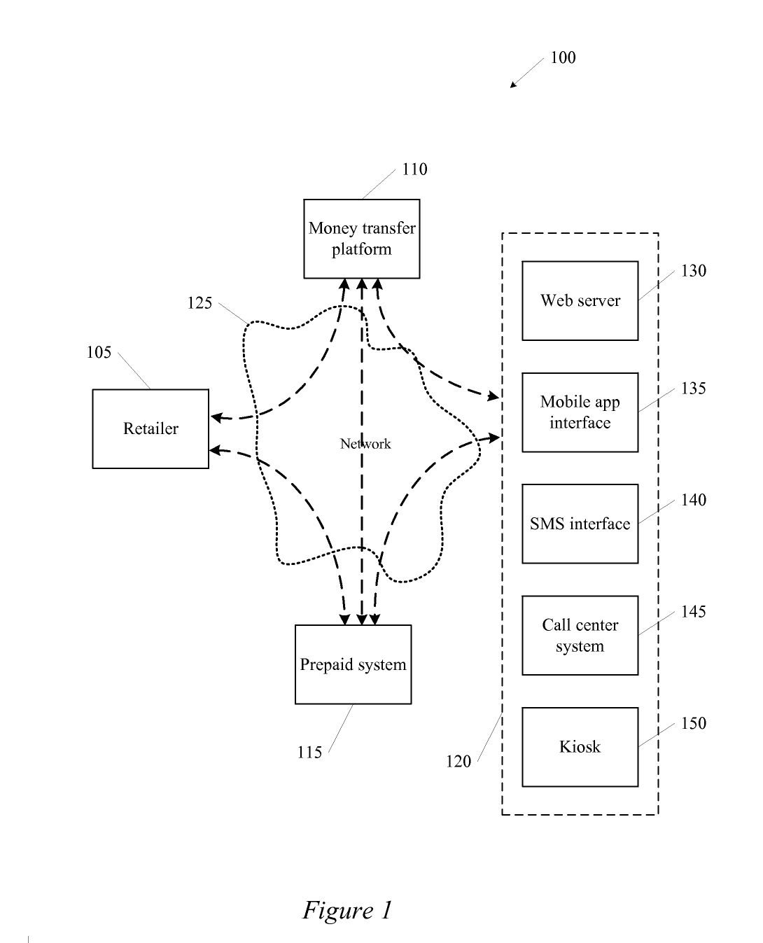

FIG. 1 is a block diagram of system 100 that can be used to reload a prepaid account according to some embodiments of the invention. Agent 105 can be any retailer, entity, person, store, or organization (e.g., one that offers products or services for sale to consumers). A reload package can include a reload identifier such as, for example, a numeric code, alphanumeric code, PIN, barcode, quick response (“QR”) code, matrix code, 2D barcode, 3D barcode, biometric sample (e.g., voice print, finger print, retinal image, facial image), etc., that can be used to associate a purchased reload package with a prepaid account. The reload identifier can be printed on the packaging material of the reload package.

Money transfer platform 110 can include any financial system that associates a prepaid account with funds. Money transfer platform 110 can include a database associating prepaid accounts with a fund account, prepaid account number, consumer information, loyalty information, etc. When a prepaid account is used in commerce, funds from the prepaid account are debited and transferred to the appropriate merchant. Additional funds can be loaded onto the prepaid account in a number of ways.

Prepaid system 115 can be an intermediary system that manages and/or processes the various prepaid accounts and/or stored value accounts sold by agent 105. Prepaid system 115 can be an intermediary between one, some, or all communication between money transfer platform 110 and agent 105.

Consumer interface 120 provides a mechanism for the consumer to establish a relationship between a prepaid account and a reload package at money transfer platform 110. A reload package can be for one-time use or it may be used by the consumer to load a prepaid account multiple times. Various systems or interfaces can be used. A number of examples are provided.

In some embodiments of the invention, consumer interface 120 can include web server 130. A consumer can send reload identifier and/or prepaid account number through a webpage hosted by web server 130. Web server 130 can then send the reload identifier and/or prepaid account number to money transfer platform 110. Moreover, web server 130 can host a website offering a variety of reload packages. Web server 130 can pre-establish a reload identifier and send the reload identifier to a consumer who has selected a specific reload package, which can have a fixed or variable reload amount associated with it. Reload identifier can include one or more of information about the consumer, reload package identifier, person identification number (PIN), reload amount, prepaid account number, etc.

In some embodiments of the invention, consumer interface 120 can include mobile application interface 135. Mobile application interface 135 can communicate with a mobile application executing on a consumer's electronic device such as a smartphone, tablet, or the like. Mobile application interface 135 can receive data from the consumer's mobile application that establishes a relationship between the consumer's prepaid account and a reload package. Establishing the relationship can take place prior to money transfer platform receiving funds for the load amount. For example, using the mobile application the consumer can photograph or scan a barcode or QR code located on a reload package and send the photographed or scanned barcode or QR code and/or information relating to the reload package to money transfer platform 110 through mobile application interface 135. The mobile application can also send the account number associated with the consumer. The barcode can provide a unique identifier associated with the reload package. Using this identifier, money transfer platform 110 can assign the reload package to the consumer's account number. Such assignment can take place prior to the consumer making a payment to load funds to the prepaid account, card or device. Then, when the consumer takes the reload package to the agent and pays for the reload package, money transfer platform 110 is ready to finalize the transaction. In addition to the reload amount, the consumer may be required to pay a reload fee. The reload fee may be paid separately by the consumer or may be deducted from the reload amount.

As another example, mobile application interface 135 can allow the consumer to enter a control number, PIN, or the like associated with either the reload package or their prepaid account. This information can be sent through mobile application interface 135 to money transfer platform 110 to assign the reload package to the consumer's account number. Such assignment can take place prior to the consumer making a payment to load funds to the prepaid account, card or device. Various other techniques can be employed using a mobile application communicating through mobile application interface 135 that sends prepaid account information and/or reload package information to money transfer platform 110.

In some embodiments of the invention, consumer interface 120 can include SMS interface 140. In some embodiments a consumer can send prepaid account information along with a reload identifier (e.g., reload package control number or PIN) using a text message through SMS interface 140 to money transfer platform 110.

In some embodiments of the invention, consumer interface 120 can include call center system 145. In some embodiments, a consumer can call a call center, interact with a call center agent, and provide pertinent information for reloading a prepaid account such as one or more of the prepaid account number, reload amount, reload package identifier, etc. The call center agent can in turn send reload identifier (e.g., reload package control number or PIN) received from the consumer through call center system 145 to money transfer platform 110.

In some embodiments of the invention, consumer interface 120 can include kiosk 150. In some embodiments a consumer can send reload identifier and or prepaid account number using software loaded at kiosk 150 to money transfer platform 110. Moreover, kiosk 130 can host a website offering a variety of reload packages or options for reloading.

The various systems, blocks, components, etc. of system 100 can be communicatively coupled together through network 125. Network 125, for example, can be a private network or a public network, like the Internet.

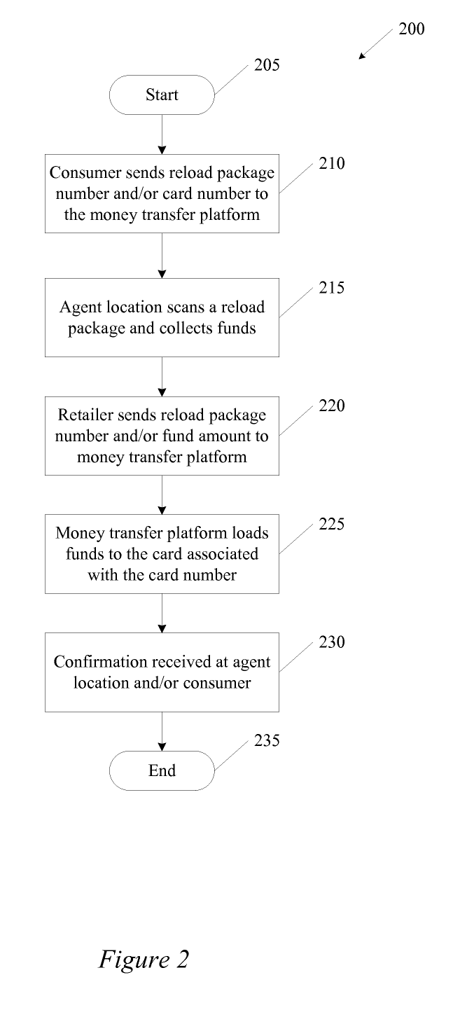

FIG. 2 is a flowchart of method 200 for reloading a prepaid account according to some embodiments of the invention. Method 200 begins at block 205. At block 210, the consumer can send reload package identifier and/or account number to money transfer platform 110. The consumer may also send a PIN to validate their identity. The reload identifier can be associated with a specific (for example, a pre-determined denomination), flexible (for example selected by the consumer) or recurring (for example, monthly, ad hoc, etc.) reload amount. The reload amount can be established by the platform provider, a processor, the program manager, the consumer or a third-party (for example, the consumer's relative). The reload package identifier and/or prepaid account number can be sent to money transfer platform 110 through consumer interface 120.

For example, the consumer can select an online reload package that includes a reload package identifier through web server 130. The consumer can send their account number to the money transfer platform through web server 120 and the account number can then be pre-associated with the reload identifier at the many transfer platform. In some embodiments, the consumer can be given a period of time to use the reload identifier before it expires. For example, this period of time can be 15 minutes, 30 minutes, 45 minutes, one hour, etc. Moreover, web server 130 can provide the reload identifier to the consumer. The consumer, for example, can print out a document with the reload identifier and/or a bar code or QR code reproduction of the reload identifier.

As another example, the consumer can select a reload package through a mobile application and send this information to money transfer platform 110 through mobile application interface 135. The mobile application can have the consumer's account number electronically stored or the consumer can enter the number. The account number can be sent to money transfer platform 110 through mobile application interface 135. Moreover, the mobile application can provide the consumer the reload identifier to the consumer through the mobile application, through email, or text. The reload identifier can be displayed as a number, character string, alpha-numeric code, bar code, QR code, etc. or any combination of the foregoing.

As another example, the consumer can select a reload package at a retail location and text reload identifier to money transfer platform 110 through SMS interface 140. The consumer can also take a picture of the reload identifier or a barcode or QR code associated with the reload identifier and this picture can be sent to money transfer platform 110 through SMS interface 140 and/or through mobile application interface 135. In some embodiments money transfer platform 110 may associate the phone number sending the text message with an account number. Furthermore, this can be done through a mobile application on the consumer's phone.

As yet another example, the consumer can select a reload package from a listing of reload packages offered from a call center representative through call center system 145. The consumer can provide their account number and it can be associated with a reload identifier. Moreover, the call center representative can tell the reload identifier to the consumer or send the reload identifier via e-mail, text message and/or through a mobile application.

As yet another example, the consumer can select a reload package from a listing of reload packages offered by kiosk 150. The consumer can provide their card or device and/or their account, and it can be associated with a reload identifier. A card or account number can be identified by manually entering the card account number, reading a magnetic stripe on a card, scanning a bar code or QR code on the card, taking a picture of or scanning the card face, etc. A device or account number can be identified through near-field communication between the device and the kiosk. Moreover, kiosk 150 can tell the reload identifier to the consumer, write the reload identifier to the magnetic stripe on the consumer's prepaid card, print the reload identifier, print a bar code or QR code associated with the reload identifier, or communicate the reload identifier to the consumer's prepaid device.

In each of the examples above, the reload identifier is associated with the consumer's account number through a number of different mechanisms.

At block 215 the agent can receive the reload identifier from the consumer; for example the agent can scan a reload package provided by the consumer, can scan a barcode or QR code on the consumer's phone that is associated with the reload identifier, can scan a printed bar code or QR code provided by the consumer, and/or can manually enter the reload identifier provided by the consumer. In either way, the reload identifier can be entered or otherwise received by the agent at the agent location along with a cash payment. The consumer may provide the prepaid card, device or account number instead of or in addition to the reload identifier. The consumer may also provide a transaction control number of PIN. In some embodiments the account number can be received from the consumer, while in other embodiments the account number is not received.

At block 220 the agent can send the reload identifier and/or fund amount to money transfer platform 110. In some embodiments the account number can be sent, while in other embodiments the account number is not sent.

At block 225 funds can be loaded onto the account by money transfer platform 110. At block 230 a confirmation that the funds have been loaded can be sent to the agent and/or to the consumer (e.g., via email, phone, text, etc.). Method 200 can end at block 235.

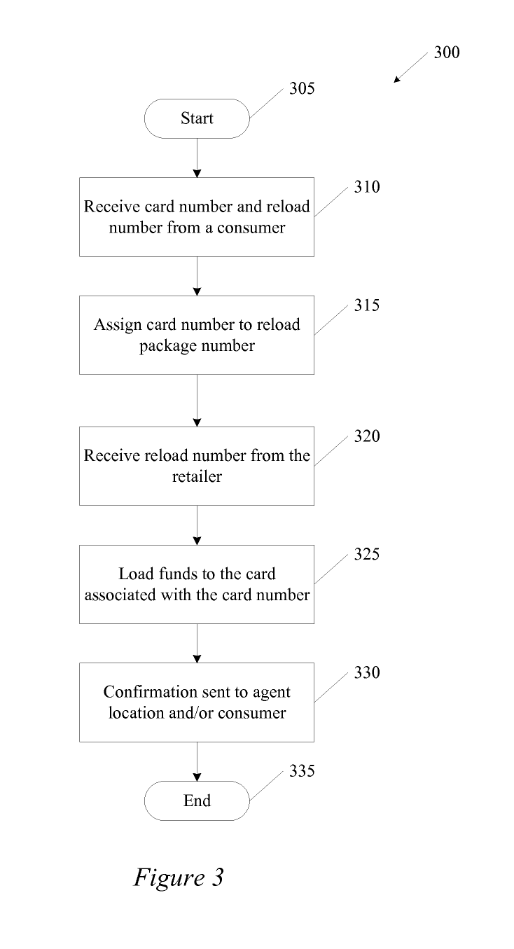

FIG. 3 is a flowchart of method 300 for reloading a prepaid account according to some embodiments of the invention. Method 300 begins at block 305. At block 310, money transfer platform 110 can receive reload identifier and/or an account number from a consumer through consumer interface 120. As noted above, this information can be sent and received through any type of interface. In some embodiments, money transfer platform 110 can receive a telephone number and/or another identifier that is associated with an account number. Using this telephone number or other identifier, the account number can be retrieved.

At block 315 the account number can be assigned to the reload identifier and/or with a money transfer control number.

At block 320 money transfer platform 110 can receive the reload identifier and/or prepaid card, device or account number from the agent. In some embodiments the reload identifier can be associated with a fixed reload amount. In such embodiments money transfer platform 110 can receive a reload amount with the reload identifier and/or prepaid card, device or account number in order to confirm that the proper amount of funds were received. In other embodiments the reload identifier and/or prepaid card, device or account number may be associated with a variable reload amount. In such embodiments money transfer platform 110 can receive a reload amount to associate with the reload identifier. In some embodiments if the reload identifier and/or prepaid card, device or account number is not received at block 320 from the consumer after a set period of time, the reload identifier may expire. In some embodiments a timer in a mobile application can display when the reload identifier expires. Moreover, reminders may be sent to the consumer through email or SMS text, or through a mobile application.

At block 325 the reload amount can be loaded onto the card or device associated with the account number. In some embodiments appropriate fees can be deducted by the agent and/or money transfer platform 110. At block 330 a confirmation message can be sent to the agent and/or consumer. Method 300 can end at block 335.

In some embodiments the consumer can indicate a fund amount when sending the reload identifier to money transfer platform 110 (e.g., at blocks 210 and 310). Money transfer platform 110 can compare the amount indicated by and/or received from the consumer and the amount associated with the reload identifier and/or received from the agent. If they match, for example, the prepaid account card can be loaded. Money transfer platform may also compare a biometric sample obtained from the consumer with a biometric sample associated with the reload identifier.

In some embodiments money transfer platform 110 can send a code to the consumer in response to receiving the reload identifier from the consumer (e.g., at block 210 and/or block 310). This code can then be requested from the consumer by the agent and sent to money transfer platform 110 (e.g., in conjunction with or after block 220 and/or block 320), for example, after the reload identifier has been sent to the money transfer platform. If the code received by the agent matches the code sent to the consumer, then funds can be loaded onto the prepaid account card. In some embodiments the code can be sent to money transfer platform 110 at or after block 220 and/or received at money transfer platform 110 at or after block 320.

In some embodiments money transfer platform 110 can flag a consumer, prepaid card or device, reload identifier and/or account card number or block a consumer from loading a prepaid account card using the embodiments of the invention if there is concern a fraudulent transaction is taking place. For example, a consumer can be flagged as a potential fraud if the consumer sends one or more reload identifiers in a short period of time and/or does not attempt to provide funds at an agent location. Similarly, an account card number can be flagged as potentially fraudulent if the account card number is associated with a reload identifier that is received at money transfer platform 110 but without an attempt fund the prepaid card or device card associated the account card number in a set period of time and/or if the account card number is associated with more than one reload identifier in a certain period of time. In some embodiments, transactions can be flagged as potentially fraudulent if a long period of time between sending the reload identifier (e.g., block 210) and the money transfer platform 110 receiving funds and/or reload identifier, prepaid card or device, or account number from the consumer or from the agent (e.g., block 220).

It should be noted that during method 300 that the consumer may not need to provide their account number to the agent. In some embodiments the consumer may provide their account number and the agent may send the account number to money transfer platform 110.

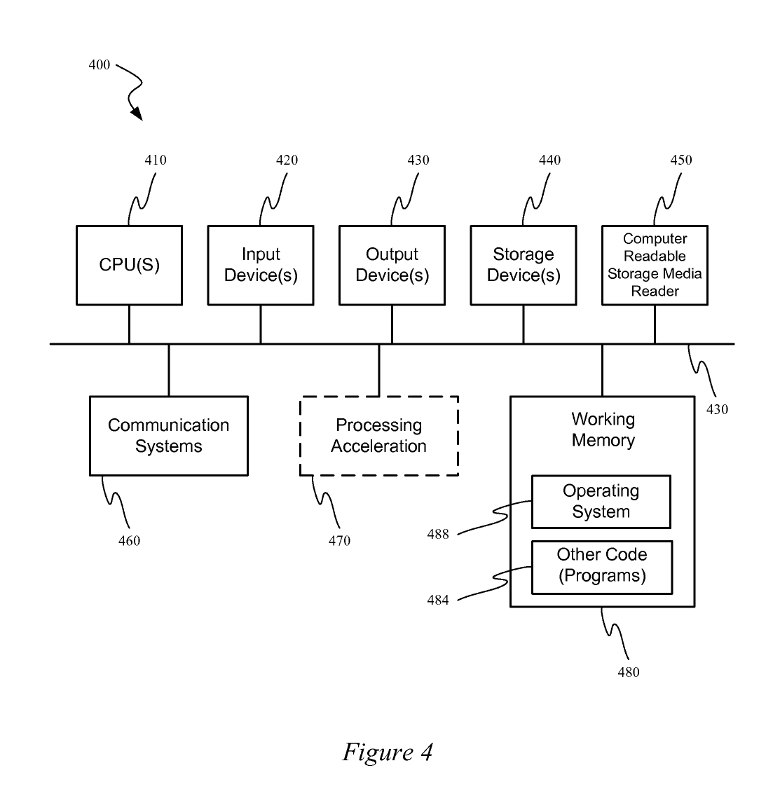

Computer system 400, shown in FIG. 4, includes hardware elements that may be electrically coupled via a bus 490. The hardware elements may include one or more central processing units 410, one or more input devices 420 (e.g., a mouse, a keyboard, etc.), and one or more output devices 430 (e.g., a display device, a printer, etc.). Computer system 400 may also include one or more storage device(s) 440. For example, storage device(s) 440 may be disk drives, optical storage devices, solid-state storage device such as a random access memory (“RAM”) and/or a read-only memory (“ROM”), which can be programmable, flash-updateable and/or the like.

Computer system 400 may additionally include a computer-readable storage media reader 450, a communications system 460 (e.g., a modem, a network card (wireless or wired), an infra-red communication device, Bluetooth™ device, cellular communication device, etc.), and working memory 480, which may include RAM and ROM devices as described above. In some embodiments, computer system 400 may also include a processing acceleration unit 470, which can include a digital signal processor, a special-purpose processor and/or the like.

Computer-readable storage media reader 450 can further be connected to a computer-readable storage medium, together (and, optionally, in combination with storage device(s) 440) comprehensively representing remote, local, fixed, and/or removable storage devices plus storage media for temporarily and/or more permanently containing computer-readable information. Communications system 460 may permit data to be exchanged with a network, system, computer and/or other component described above.

Computer system 400 may also comprise software elements, shown as being currently located within a working memory 480, including an operating system 484 and/or other code 488. It should be appreciated that alternate embodiments of computer system 400 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 400 may include code 488 for implementing any or all of the function of the various elements of the architecture as described herein. For example, software, stored on and/or executed by a system such as computer system 400, can provide the functions of the stored value provider subsystem, user subsystem, bill payment subsystem, gateway subsystem, and/or other components of the invention such as those discussed above. Methods implementable by software on some of these components have been discussed above in more detail.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method comprising:
receiving, at a money transfer platform computer system, an account number from a consumer, wherein the account number is associated with a prepaid account;
receiving, at a money transfer platform computer system, a request from the consumer to load the prepaid account, wherein the request is associated with a reload identifier;
associating, at a money transfer platform computer system, the account number with the reload identifier;
receiving, at a money transfer platform computer system, the reload identifier and a fund amount after receiving the request from the consumer;
looking up the account number using the reload identifier, at a money transfer platform computer system; and
loading the reload amount onto the prepaid account, at a money transfer platform computer system.

2. The method according to claim 1, wherein receiving the reload identifier and a fund amount from an agent does not include receiving the account number from the agent.

3. The method according to claim 1, further comprising determining whether the fund amount equals an amount associated with the reload identifier.

4. The method according to claim 1, further comprising determining whether the fund amount minus any fees equals an amount associated with the reload identifier.

5. The method according to claim 1, wherein the account number is not received from the agent.

6. The method according to claim 1, wherein the account number and the request from the consumer are received through a web interface.

7. The method according to claim 1, wherein the account number and the request from the consumer are received through an SMS interface.

8. The method according to claim 1, wherein the account number and the request from the consumer are received through a kiosk.

9. The method according to claim 1, wherein the account number and the request from the consumer are received through a call center.

10. The method according to claim 1, wherein the account number and the request from the consumer are received through a mobile application interface.

11. The method according to claim 1, wherein the receiving a request from the consumer to load the prepaid account, wherein the request is associated with a reload identifier comprises receiving a photograph of a barcode associated with the reload identifier.

12. The method according to claim 1, wherein the receiving a request from the consumer to load the prepaid account, wherein the request is associated with a reload identifier comprises receiving the reload identifier from the consumer.

13. A system for loading funds to a prepaid account, the system comprising:
a consumer interface;
an agent interface;
a database, and
a money transfer processor coupled with the consumer interface, the agent interface, and the database; the processor configured to:
receive communication from the consumer through the consumer interface that includes a prepaid account number;
associate, in the database, the prepaid account number with a reload identifier;
send the consumer a reload identifier through the consumer interface;
receive the reload identifier and a fund amount through the agent interface;
look up the prepaid account number in the database using the reload identifier; and
load the prepaid account with fund amount.

14. The system according to claim 13, wherein the reload identifier is provided to the consumer.

15. The system according to claim 13, wherein the reload identifier is received from an agent of the money transfer platform.

16. The system according to claim 13, wherein the consumer interface and the agent interface are distinct.

17. The system according to claim 13, wherein consumer interface comprises a web interface.

18. The system according to claim 13, wherein consumer interface comprises an SMS interface.

19. The system according to claim 13, wherein the consumer interface comprises a call center interface.

20. The system according to claim 13, wherein the consumer interface comprises a kiosk.

21. The system according to claim 13, wherein the consumer interface comprises a mobile application interface.

22. A non-transitory computer-readable medium for loading funds to a prepaid account at a money transfer platform, having sets of instructions stored thereon which, when executed by a computer, cause the computer to:
receive an account number from a consumer, wherein the account number is associated with a prepaid account;
receive a request from the consumer to load the prepaid account, wherein the request is associated with a reload identifier;
associate the account number with the reload identifier;
receive the reload identifier and a fund amount after receiving the request from the consumer;
look up the account number using the reload identifier; and
load the reload amount onto the prepaid account.
